(19) United States
(12) Patent Application Publication
(10) Pub. No.: US 2008/0191595 A1
(43) Pub. Date: Aug. 14, 2008

(54) SL plane embedded type noble metal spark plug with multi-level and high energy

(76) Inventor: Dimin HUA, Cixi City (CN)

Correspondence Address: ERIC CHAN, 42 PIN OAKS DRIVE, PHOENIXVILLE, PA, 19460, US

(21) Appl. No.: 11/838,855

(22) Filed: Aug. 14, 2007

(30) Foreign Application Priority Data
Feb. 8, 2007 (CN) 200710007198.6

(51) Int. Cl. H01T 13/20

(52) U.S. Cl. 313/141

(57) ABSTRACT

The present invention relates to a kind of spark plug called “SL plane embedded type noble metal spark plug with multi-level and high energy”, which is not only generates high ignition energy required by motor, but also generates three high ignition energies instantly at the same moment so as to facilitate full mixture of fuel and gas in motor. The working condition of motor will be steady, the power will increase, the fuel consumption will decrease, and the discharge of waste gas will be improved obviously. Embed three noble metal electrodes with equal distance into small end face of ceramic isolator of spark plug and integrate them with the ceramic isolator at high temperature; weld a noble metal electrode to the threaded end face of spark plug case, which is in line with these three noble metal electrodes which are installed on the ceramic isolator with an equal distance, then form four linear noble metal electrodes with the equal distance and have three high ignition energies instantly at the same moment to obtain the anticipating result. Meanwhile, this invention has eliminated so called “hot chamber volume”, which has a feature of “a broad heat value” and this type of spark plug can replace more than four flask plugs of different heat values.

### BACKGROUND OF THE INVENTION

This invention refers to a crucial component which is widely applied to the ignition system of motor (including various motors that need electric ignition by consuming gasoline, natural gas and liquefied gas, etc.), especially for spark plug that has a significant influence on working condition of motor, fuel consumption decreasing, and discharge of waste gas, etc.

Normally, the spark plug is constituted by wiring screw nut, wiring screw rod, sealing material, centre electrode, inner gasket, outer gasket and side electrode, etc. It has over hundred years since the spark plug was invented in 1902, but the structure of spark plug has not achieved a situation of instantaneously generating more than two ignition energies at the same moment. At present, there are various monopole or multi-pole spark plugs or something else, all of them apply a principle that one or more electrode space is formed between the center electrode and one or more side electrode. The principle of puncturing from electrode in min. distance determines spark plugs of different kinds could not generate multi-ignition energy instantaneously at present.

### BRIEF SUMMARY OF THE INVENTION

This invention provides us a kind of spark plug, which not only generates high ignition energy required by motor, but also generates three high ignition energies instantly at the same moment so as to facilitate full mixture of fuel and gas in motor. The working condition of motor will be steady, the power will increase, the fuel consumption will decrease, and the waste gas discharge will be improved obviously.

The technological solution applied to this invention is as following: Embed three noble metal electrodes into a small end face of ceramic isolator in line and with equal distance, and these three noble metal electrodes will be firmly installed on the ceramic isolator after high-temperature sintering, one of the noble metal electrodes shall be syncretized with conductive sealing material to form a centre electrode connecting with the wiring screw rod; a noble metal electrode is welded to the threaded end face of spark plug case, opposite to the last noble metal electrode on the ceramic isolator and in line with these three electrodes which are installed on the ceramic isolator.

After assembly of the spark plug, four noble metal electrodes have formed a straight line on the ignition end of the spark plug. After high voltage power has been connected to the wiring screw rod, the ignition end of spark plug is able to generate three ignition energies instantly at the same moment through conductive sealing material and the noble metal centre electrode. The resistance is quite small, the conductive performance is very excellent, the energy of ignition is very high and the combustion of fuel mixture is rather sufficient thanks to using noble metal. Naturally, the working condition of motor is good and power is very large, which facilitates decrease of fuel consumption and improvement of waste gas discharging.

This invention has another unique character that is “a broad heat value”. Usually, every spark plug has a specific “hot chamber volume”; due to different motors select spark plug with different heat values otherwise the motor could not operate normally, the species and quantity of spark plug are increasing enormously, while this invention has creatively eliminated “hot chamber volume”. One spark plug of this invention could replace more than four spark plugs of different heat values which have been testified by us, and it has an important significance for production and use of spark plug.

### BRIEF DESCRIPTION OF THE DRAWINGS

Illustration to this invention is as following:

FIG. 1 is the profile for “SL plane embedded type noble metal spark plug with multi-level and high energy” FIG. 2 is the partial enlargement drawing for Part A in FIG. 1.

FIG. 3 is the end face drawing for FIG. 1

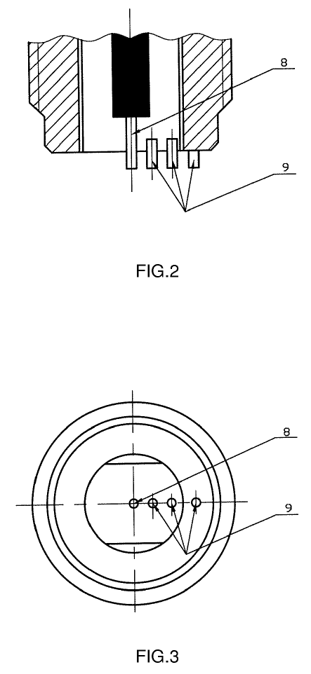

1—wiring screw nut, 2—wiring screw rod, 3—ceramic isolator, 4—case, 5—outer gasket, 6—conductive sealing material, 7—inner gasket, 8—noble metal centre electrode, 9—noble metal side electrode.

### DETAILED DESCRIPTION OF THE INVENTION

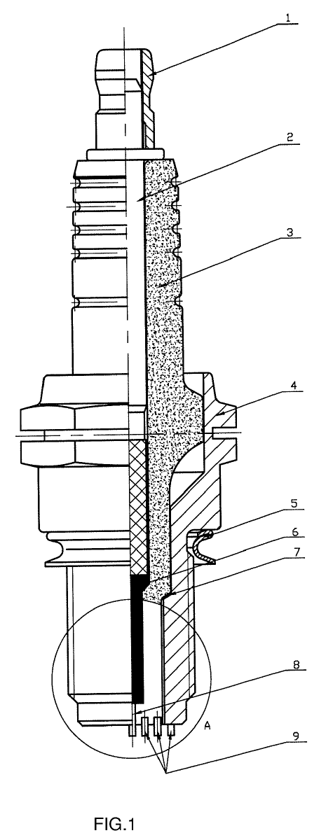

In FIG. 1, embed metal centre electrode 8 and two noble metal side electrodes 9 on the ceramic isolator into small holes which are arranged in line on small head of the ceramic isolator with the equal distance in advance, and the length of electrode 8 and 9 are 5.1 mm with a tolerance not more than ±0.10 mm, and then sinter them together in a high-temperature furnace chamber under temperature of 1650° C., and the height of these noble metal electrodes after sintering shall be assured within 1 mm. The said noble metal is Pt at present. Until the ceramic isolator with embedded noble metal electrodes has been completed, install conductive sealing material 6 and wiring screw rod 2 then sinter them in a sealing sintering furnace to form an isolation part. Weld a noble metal electrode to the threaded end face of case 4, ascertain the correct position before welding and assure the welded noble metal side electrode is in line with these two noble metal side electrodes which are installed on the ceramic isolator with an electrode space of 0.6±0.10 mm. After the case is welded with noble metal side electrode and electroplated, assemble it with inner gasket 7, outer gasket 5 and wiring screw nut 1 to form a finished spark plug.

What is claimed is:

1. SL plane embedded type noble metal spark plug with multi-level and high energy comprises a wiring screw nut (1), a wiring screw rod (2), a ceramic isolator (3) and case (4) are set outside of the wiring screw rod (2), an outer gasket is set out of the case (4), an inner gasket is set between the ceramic isolator (3) and the case (4), characterized in that a centre electrode made of noble metal on small end face of the said ceramic isolator shall be embedded into the small hole of ceramic isolator processed in advance as a specific length, two noble metal side electrodes shall be embedded into the small hole of ceramic isolator processed in advance as well, these three noble metal electrodes have formed a straight line with the equal distance, and integrate the ceramic isolator with the noble metal centre electrode and the noble metal side electrodes by high temperature sintering and the height of these noble metal electrodes shall be kept within 1 mm.

2. The spark plug according to claim 1, characterized in that a side electrode made of noble metal shall be welded to the thread side of the case (4) with a specific length; the said side electrode is in line with the two side electrodes of the ceramic isolator (3) with the equal distance.
